(19) United States
(12) Patent Application Publication
(10) Pub. No.: US 2026/0323791 A1
(43) Pub. Date: Oct. 15, 2026

(54) WORKPIECE HOLDING DEVICE AND INDUCTIVE HARDENING SYSTEM

(71) Applicant: AKTIEBOLAGET SKF, GOTEBORG (SE)

(72) Inventors: Michael WENDEL, Bremen (DE); Martina STICHT, Sennfeld (DE)

(21) Appl. No.: 19/640,791

(22) Filed: Apr. 7, 2026

(30) Foreign Application Priority Data
Apr. 15, 2025 (DE) 102025114638.1

(51) Int. Cl. H05B 6/40; C21D 1/10; C21D 11/00; H05B 6/06; H05B 6/44

(52) U.S. Cl. CPC H05B 6/40; C21D 1/10; C21D 11/00; H05B 6/06; H05B 6/44

(57) ABSTRACT

A workpiece holding device for holding a workpiece in a heat treatment system while the workpiece undergoes a thermal expansion. The device includes at least three support units configured to support the workpiece for rotation about a workpiece rotational axis and first, second and third contact units configured to cooperate with the workpiece to limit translational movement of the workpiece in a radial plane of the workpiece during a rotational movement of the workpiece relative to a heating device. The contact units are configured such that a distance between the second and third contact units remains fixed during a thermal expansion of the workpiece and such that a distance between the first contact unit and the second contact unit is changeable during the thermal expansion.

### CROSS-REFERENCE

This application claims priority to German patent application no. 10 2025 114 638.1 filed on Apr. 15, 2025, the contents of which are fully incorporated herein by reference.

### TECHNOLOGICAL FIELD

The present disclosure relates to a workpiece holding device for holding a workpiece in a heat treatment system in which the workpiece undergoes thermal expansion and/or contraction due to the heat treatment or due to a density difference arising in the structure during a phase transformation that may occur during the heat treatment. The disclosure also relates to an inductive hardening system.

### BACKGROUND

In order to thermally treat workpieces, for example to heat or quench them, the workpieces must be arranged securely and precisely in position in the treatment plant in order to achieve very precise heat inputs and subsequently defined quenching processes in the treatment zones. For this purpose, conventional clamping devices can be used, such as so-called three- or four-jaw chucks, which have three or four clamping jaws that are mounted on a workbench and are grouped peripherally around the workpiece to be held. The workpiece is clamped and held in these clamping jaws before treatment, and it is possible to adjust the clamping jaws in order to compensate for thermal contraction and/or expansion or for contraction and/or expansion resulting from a difference in density arising during a phase transformation in the structure. It is also known in such devices to move the entire workbench together with the clamping jaws past fixed heat sources, such as inductors, in order to simplify the adjustment of the supply lines required for the heat sources.

However, a disadvantage of such devices is that the force required to adjust the jaws due to the thermal expansion or contraction to be compensated for, or due to an expansion or contraction resulting from a density difference arising from a phase transformation in the structure, may be too low, and it may then happen that the jaws no longer rest against the workpiece and are therefore unable to hold it sufficiently firmly, or that excessive force exerted by the jaws leads to deformation of the workpiece or to an unfavorable internal stress state in the workpiece. In addition, all jaws must be actuated, which leads to a very high control effort.

Another problem with the known devices is that the large mass to be moved, comprising the workbench, clamping jaws and workpiece, leads to very high energy consumption and wear in the drive system of the workbench, so that its components often have to be replaced or the drive has to be completely replaced. In addition, the process parameters, such as the relative speed between the heat source, such as an inductor, and the workpiece, are limited due to the large mass to be moved and the overall dimensions of the device, so that optimized heat input into the workpiece cannot always be achieved.

However, the heat input and the distribution of the heat input in the workpiece are of enormous importance in order to achieve the desired workpiece properties in the treatment zones and to control the resulting dimensional and shape changes (workpiece distortion). Known ways of influencing the heat input and temperature distribution in the case of inductive heating, for example, are the appropriate choice of process parameters or process design (electrical power, heating time, heating frequency, coupling distance between inductor and workpiece, inductor material, inductor design, targeted use of magnetic field concentrators, workpiece material, initial condition of the workpiece material, relative speed of the workpiece in relation to the inductor, etc.).

Thus, a crucial element of the heat treatment plant and the success of the heat treatment is the workpiece holding device.

### SUMMARY

It is therefore an aspect of the present disclosure to provide a workpiece holding device, in particular a workpiece clamping system, which fulfils the following functions, preferably in their entirety: ensuring a predefined coupling distance between the inductor and the workpiece; positioning the workpiece in a defined position; holding the workpiece in a defined position throughout the entire process time, counteracting any forces acting on it (e.g. magnetic fields); ensuring good reproducibility of the heat treatment; enabling heat treatment at all positions of the workpiece (inside, outside, top and bottom side faces); preventing cracking; minimizing workpiece distortion or deformation; moving the workpiece safely at a defined speed, which can be changed during the process; applying clamping forces that can be changed during the process.

The following describes a workpiece holding device for holding a workpiece in a heat treatment system, in particular a hardening system for hardening at least part of the workpiece. The workpiece held in the workpiece holding device undergoes thermal expansion and/or contraction or expansion and/or contraction resulting from a difference in density arising during a phase transformation in the structure. In the following, reference will be made mostly to thermal expansion or contraction, since a thermal component is usually also present during a phase transformation.

The workpiece itself has a closed curved profile and a substantially radial inner surface and a substantially radial outer surface and can be heated by a heating device, whereby it undergoes thermal expansion and/or contraction. The workpiece is preferably rotationally symmetrical, such as an element of a plain or rolling bearing, a bearing ring, a gear wheel, a bolt, a sleeve, a disc, etc.

In order to reduce wear on the components of the workpiece holding device, in particular due to high mass, and at the same time to optimize the heat input into the workpiece, the workpiece held in the workpiece holding device is mounted so as to be rotatable about an axis of rotation. Since only the workpiece needs to be set in motion and not the entire unit including the workpiece, workbench, clamping units and other equipment, a significant reduction in the weight of the parts to be set in motion can be achieved, even with large workpieces. This in turn also allows, in addition to the lower loading of the components and thus also less wear on the components of a drive system, a more precise adjustment of the process parameters, such as the rotational speed, and thus an improved heat input into the workpiece. Furthermore, less energy needs to be used to set the workpiece in rotation than in the case of conventional systems, such that a cost reduction is also possible as a result.

Furthermore, the workpiece holding device has at least three support units configured to support the workpiece and at least three contact units configured to position the workpiece in the workpiece holding device in a predefined radial and axial position.

In order to simplify actuation and control and to provide a heat treatment system that is as robust and easy to operate as possible, but at the same time provides precise radial positioning of the workpiece in the heat treatment system, two of the three contact units are configured as passive contact units and one of the three contact units is an active contact unit, wherein the active contact unit is configured to actively apply a radial clamping force to the workpiece.

It should be noted that, in the context of the application, the terms “open-loop control” and “closed-loop control” are not used in the strict technical jargon of electrical engineering. Thus, "control" is used to describe both instances.

Surprisingly, it has been shown that it is sufficient to hold the workpiece in a predefined position using only an actively controllable contact unit, while still ensuring that the workpiece can be held and positioned in a defined radial position throughout the entire process time, even against any forces acting on it, such as magnetic fields from inductors. At the same time, the three contact units can be used to exert a particularly uniform clamping force on the workpiece and secure it in its position with high precision. This also allows a predefined coupling distance between the inductor and the workpiece to be set. This in turn enables good reproducibility of the heat treatment. Since only three contact units are provided, heat treatment can be easily carried out at all positions of the workpiece (inside, outside, top and bottom side faces).

It is also sufficient that only the active contact unit is radially adjustable to accommodate different workpiece sizes. This significantly simplifies workpiece mounting, as only one contact unit needs to be adjusted to the size of the workpiece. This also ensures that, regardless of the size of the workpiece, the workpiece is always centered in the workpiece holder.

Alternatively, as another advantageous exemplary embodiment shows, it may of course also be preferable that, in order to adapt the workpiece holder to different sizes of workpieces, the three contact units are all configured to be radially movable, for example by means of an electric or hydraulic drive, and are moved towards the workpiece before the heat treatment until the workpiece is held firmly between the clamping units. During operation, however, two of the contact units are radially fixed and represent the passive contact units, while the third active contact unit is also radially movable during operation in order to secure the workpiece in its position with high precision and to compensate for manufacturing tolerances during operation. In addition, the active contact unit can be mounted so that it can be displaced eccentrically. This allows the active contact unit to follow the thermal expansion/contraction of the workpiece. The eccentric mounting allows both radial and tangential movement of the contact unit.

Furthermore, an exemplary embodiment is advantageous in which each contact unit has a contact element that is configured to bear against the radial inner surface and/or radial outer surface of the workpiece, wherein the contact elements of the passive contact unit are configured as passive contact elements that are fixed in the radial direction during operation, and the contact element of the active contact unit is configured as an active contact element which is movable in the radial direction during operation in order to apply the radial clamping force to the workpiece and to secure the workpiece in its radial and axial position with high precision.

With the aid of the active contact element, the workpiece can be clamped with a defined force and defined force application points. In addition, this can make it possible to compensate for workpiece shrinkage or reduced workpiece growth due to thermal contraction in the temperature range of the phase transformations from ferrite/α-iron to austenite/γ-iron (A1 temperature to A3 temperature, at approximately 740° C. to 860° C. depending on the steel, microstructure and heating rate) and/or due to subsequent cooling. At the same time, however, the active contact element can also be used to monitor workpiece growth or reduced workpiece shrinkage due to the increase in volume during quenching in the range of the phase transformation from austenite/γ-iron to martensite and/or bainite/pearlite/ferrite (this temperature range for martensite formation can typically be between approximately 400° C. and 100° C., depending on the solution state and steel).

It is particularly advantageous if, in the case of a workpiece to be treated in a substantially circular manner, the active contact element is movable not only radially but also axially and/or tangentially. This allows not only thermal expansion/contraction during the thermal processing of the workpiece to be absorbed, but also manufacturing tolerances, such as a certain ovality of the workpiece when clamped, to be compensated for. Such an adjustment is particularly advantageous for workpieces with a closed curved profile, such as elements of a plain or rolling bearing, bearing rings, gear wheels, bolts, sleeves, discs, etc.

A further embodiment provides for axially acting hold-down devices which can also follow the axial direction of thermal expansion/contraction of the workpiece. These enable the workpiece to be held securely in position even in the case of lightweight workpieces and with strong magnetic fields from the induction coils.

According to a further preferred exemplary embodiment, the three contact units in the workpiece holding device are arranged at equal distances from each other at an angle of substantially 120°. This enables a uniform contact force at all contact units.

Alternatively, however, it may also be preferable for the contact units to be arranged in the workpiece holding device in such a way that an angle of less than or more than 120° is formed between the passive contact units and the active contact unit is arranged at an equal distance from the two passive contact units. This makes it possible for the two passive contact units to be radially fixed regardless of the size of the workpiece. For larger workpieces, the angle between the two passive contact units is then reduced, while for smaller workpieces the angle is increased. However, the active contact unit, which is equidistant from the passive contact units, ensures that an even clamping force is always applied to the workpiece.

According to a further advantageous exemplary embodiment, at least one of the contact units is configured as a driven rotatable contact unit which is driven by a drive unit and is configured to rotate the workpiece held in the workpiece holding device. The driven rotatable contact unit may be the active and/or passive contact unit. Preferably, all contact units, both the two passive ones and the active one, are driven.

Preferably, only a single drive unit may be provided, which drives the at least one driven rotatable contact unit. This makes it possible to provide a workpiece holding device that is particularly easy to actuate.

Furthermore, an exemplary embodiment is preferred in which the at least one driven rotatable contact unit has a driven rotatable drive element, such as a friction wheel or a friction roller, which is configured to bear against the workpiece with a determinable frictional force and to interact with the workpiece in a frictionally engaged manner in order to rotate it. This allows a particularly simple and cost-effective drive to be provided for the workpiece.

It is particularly advantageous if the frictional force applied between the drive element, in particular the friction wheel or friction roller, and the workpiece is defined by a directly applied contact force between the active contact element and workpiece and/or an indirect contact force between the passive contact element and workpiece. This ensures that an optimized drive for the workpiece is provided even in the event of thermal contraction or expansion of the workpiece.

It is advantageous in particular if a measuring device, for example a pressure sensor, which determines the contact force is provided at least on one of the contact units, in particular on the active contact unit. Another advantage is an embodiment in which, based on the measured contact force, a control unit can control the active contact unit in such a way that the contact force and thus the friction force is optimized. This can ensure that the workpiece is always driven with a constant force, even in the event of thermal expansion or contraction or structural irregularities, such as unbalance. Damage due to excessive action of force on the workpiece is also avoided.

Furthermore, it can thus also be ensured that slip between the workpiece and contact unit is minimized. The determined contact force can also minimize wear between the workpiece and the contact unit. This can also minimize the workpiece distortion and/or prevent or minimize plastic workpiece deformation. In addition, the defined friction force allows precise adjustment of the rotational speed, so that it is possible, in particular, to allow the workpiece to rotate at a defined speed.

According to a further advantageous exemplary embodiment, the contact unit has at least one measuring device for detecting changes in shape and dimensions during the heating process and after completion of the heating process (distortion). The recorded data can also be used for subsequent machining processes in order to make workpiece-specific adjustments to the processes. In a preferred exemplary embodiment, at least one contact unit, in particular the active contact element, has at least one force measuring device which interacts with the control unit and is configured to measure the contact force with which the contact unit, in particular the active contact element, contacts the workpiece.

It is also advantageous if the active contact element is preloaded. The preload of the active contact element can be achieved by means of a mechanical preloading element, such as a spring. Mechanical preloading elements can be easily installed and do not require additional actuation, which makes the workpiece holding device easy to operate and inexpensive overall.

The mechanical preloading element can be at least one spring element that interacts with the active contact element and preloads the active contact element in the direction of the workpiece. The spring element can be, for example, a wire spring, a disc spring, a coil spring and/or a leaf spring, but plastics such as an elastomer can also be used.

It is also possible for the mechanical preload to be configured as a friction device that only allows the active contact element to move once a certain coefficient of friction has been exceeded. This means that, based on the pressure exerted on the movable element by an expanding/contracting workpiece during thermal processing, the active contact element can only move once a certain threshold value has been exceeded.

Instead of a mechanical preloading device, the active contact element can also be preloaded by a device that can be actuated via a control unit. The preload can be applied, for example, by a hydraulically, pneumatically and/or electrically operated element that follows the thermal expansion/contraction or an expansion/contraction caused by a difference in density arising during phase transformation in the structure. For example, the active contact element can be an oil- or gas-operated pressure damper.

With preloads actuated by a control unit, it is already possible to follow the contraction/expansion with particular accuracy. In order to further increase the accuracy and sensitivity of the following, as mentioned above, the contact unit, the support unit and/or the drive unit can be equipped with at least one force measuring device that interacts with the control unit and is configured to measure the contact force, clamping force and/or friction force. Depending on this measured force, the control unit can then actuate the contact unit, the support unit and/or the drive unit in order to exert a uniform force on the workpiece during treatment. The force measuring device also allows for adjustment to manufacturing inaccuracies when clamping the workpiece in the workpiece holding device, so that uniform pressure is achieved on the various clamping units as soon as the workpiece is clamped.

Alternatively or additionally, the control unit can of course also actuate the contact unit, the support unit and/or the drive unit based on a pre-calculated value table in order to compensate for the calculated and expected expansions/contractions. The value table can be determined empirically and/or stored in a database accessible to the control unit. This means that the database can be stored internally in the control unit itself or in an external database.

In a preferred embodiment, the control unit can also react to forces acting on the workpiece by the processing system and, depending on the measured forces or in a predictive manner, specifically increase or decrease a preload. For example, in anticipation of electrical, mechanical or magnetic forces that temporarily act on the workpiece, the current preload can be specifically controlled and increased or decreased by a preload value. This temporary superimposition of the preload controlled due to thermal expansion with a controlled offset can preferably be switched on and off as required. Here, too, the contact unit, support unit and/or drive unit can be actuated on the basis of a value table in order to reliably absorb and/or compensate for the calculated and expected forces on the workpiece. Furthermore, the control unit can be configured in such a way that it can be switched from closed-loop-controlled operation, in which the preload forces are set based on measured values from the force measuring device, e.g. a load cell, to open-loop-controlled operation, in which the preload forces are set based on a value table, and can be switched back from open-loop-controlled operation to closed-loop-controlled operation accordingly. For example, it is possible to control the preload to a certain preload pressure as far as possible or completely during thermal expansion and to increase the preload pressure to a fixed value during subsequent thermal contraction, such as rapid quenching.

The value table or a setting of the clamping force, contact force and/or friction force based on values in the value table may depend in particular on measured and/or calculated temperature changes or tactile or optically measured or calculated diameter changes of the workpiece that are to be expected during the machining process in the workpiece.

According to a further preferred embodiment, the contact element is configured as a sliding shoe, which preferably has a contact surface resting against the radial inner surface and/or radial outer surface, wherein the contact surface preferably has a curvature that is adapted to a curvature of the radial inner surface and/or radial outer surface. Such a sliding shoe enables particularly precise guidance and uniform clamping of the workpiece, wherein the clamping force is distributed over a relatively large area. It is particularly preferred if the passive contact elements are configured as sliding shoes. Such embodiments are particularly advantageous if any distortion during heat treatment, including due to the effect of the clamping force, is to be avoided.

According to a further preferred exemplary embodiment, at least one of the contact elements is configured as a rotatable contact element resting against the workpiece. Preferably, its axis of rotation is substantially parallel to the axis of rotation of the workpiece. Of course, an axis of rotation that is inclined relative to the axis of rotation of the workpiece is also possible.

Alternatively or additionally, the support units each have at least one rotatable support element on which the workpiece rests and of which the axis of rotation is preferably perpendicular to an axis of rotation of the workpiece. This reduces friction between the workpiece and the support element, enabling rapid rotation of the workpiece in the workpiece holder. In addition, the energy consumption for rotating the workpiece is reduced.

Advantageously, all support elements are passively configured, i.e. they are only set in rotation by the rotation of the workpiece. It is particularly advantageous to design the support elements as balls. These enable simple passive rotation. In addition, due to the point contact of the workpiece on the balls, the balls enable an almost frictionless, slip-reduced/slip-free mounting of the workpiece during rotation and heat treatment.

Of course, it is also possible to configured at least one of the support elements as a drive element, such as a friction wheel or friction roller, and to actively drive it. This can be provided as an alternative or in addition to the at least one driven contact element. It is particularly advantageous if all drive elements, whether they are a support element and/or a contact element, are driven by a single drive unit. Of course, each drive element can also be driven separately by a drive unit.

Furthermore, as already indicated above, a preferred exemplary embodiment is one in which only one of the rotatable contact elements and/or support elements is actively driven, with the other two rotatable contact elements/support elements being passively set in rotation by the movement of the workpiece. This enables particularly low-friction and energy-saving movement of the workpiece.

A particularly preferred exemplary embodiment is one in which all rotatable support elements are passively configured and only rotate with the rotation of the workpiece resting on them. The rotation of the workpiece, on the other hand, is achieved by the driven contact elements. It is again preferred that all contact elements or contact units are driven, regardless of whether they are configured as active or passive contact elements/contact units. The terms “active contact unit” and “passive contact unit”/“contact element” refer in the sense of this application to the radial movability and adjustability during operation, as described above.

As already mentioned above, the driven contact elements are preferably driven synchronously by a single drive unit.

According to a further preferred exemplary embodiment, at least one rotational speed measuring unit is furthermore provided and determines a rotational speed of the drive unit or of the drive element. The drive unit or the drive element can be realized on the contact unit or the contact element and/or also on the support unit or the support element.

In addition, a further rotational speed measuring unit may preferably be provided on one of the passive rotating contact elements/support elements and determines a rotational speed of the passively driven contact elements and/or support elements.

Furthermore, a control unit is preferably provided which is configured to determine a slip of the workpiece from a speed difference between the actively and passively driven contact elements/support elements. In addition to the contact force determination described above, the rotational speed measurement can also be used to determine whether there is sufficient friction force/contact force of the drive elements or whether the clamping force applied by the contact units/contact elements is sufficient to secure the workpiece sufficiently firmly in the workpiece holder. For example, the control unit can be configured to control the drive unit and/or the contact unit and/or the support unit in order to optimize the contact force or clamping force and minimize slip.

It is particularly advantageous if the control unit is also configured to increase the contact force of the contact element, such as the friction roller/friction wheel, and/or the clamping force of the contact units when a predetermined speed difference is exceeded, and/or to issue a message about increased slip.

Alternatively or additionally, the axis of rotation of the contact element and/or the support element may be oriented parallel to a surface of the workpiece to be rotated. These rotatable contact elements/support elements can, for example, be passively moved along with the workpiece when it is moved, thereby reducing friction when the workpiece is moved.

According to a further advantageous exemplary embodiment, at least one of the contact elements and/or support elements has a cylindrical, conical, spherical and/or ball-shaped form. The exact shape may depend on several factors. On the one hand, the shape can be adapted to the shape or curvature of the radial inner or outer surface (contact surfaces) and/or to the shape or curvature of an axial support surface of the workpiece. It is particularly preferable that the rotating contact element/support elements touch the workpiece along a line. This enables a pure rotational movement between the rotating contact element(s)/support element(s) and the workpiece without any sliding movement. However, it is equally possible to select the shape for minimal contact but sufficient contact force/support force. The shape may also be selected on the basis of rotational considerations. Furthermore, it is possible that the contact units/support units have different rotatable contact elements/support elements. In addition, it may be provided that the rotatable contact elements/support elements only have a friction lining or a friction coating, which provides the active drive.

According to a further preferred exemplary embodiment, at least one of the contact elements/support elements is detachably fastened to the associated contact unit/support unit. The associated contact unit/support unit has a pin or rod, onto which the contact element/support element can be attached, and the contact element/support element is configured as a slip-on sleeve. This allows the contact element/support element to be easily replaced, for example to adapt the contact element/support element to the workpiece to be treated and/or to replace the contact element/support element during maintenance work.

In addition, it is also advantageous that the position of the replaceable contact element/support element, in particular the radial distance of the replaceable support element from a center point of the workpiece holding device and/or the axial extent of the contact element, can be adjusted as desired. This makes it possible for workpieces of different shapes and sizes, in particular with different diameters and/or different heights, to be received by the workpiece holding device.

According to a further preferred exemplary embodiment, the at least one contact unit and/or support unit further comprises an adjustment device which is configured to adjust an angular position of the contact element and/or support element. This also enables the contact elements/support elements to be adapted particularly well to the geometry of the workpiece. For example, with the aid of the adjustment device, it is possible to use a cylindrical contact element/support element even for inclined radial surfaces and still guide the rotating contact element/support element with line contact on the workpiece. Alternatively, a conical sleeve could also be used here.

Furthermore, it is preferable that the rotatable contact element and/or support element is configured as a sleeve that can be attached to the contact unit or support unit and has a straight or curved outer surface, in particular a cylindrical, conical, spherical and/or toroidal shape.

In particular, an exemplary embodiment is preferred in which the contact element has a conical shape that protrudes beyond an upper edge of the workpiece in the direction of the workpiece, so that the contact element serves not only as a radial contact element but also as an axially acting contact element. The axial contact ensures that the workpiece is held in the workpiece holder in the direction of the support unit, so that the contact element serves as a hold-down device.

Another aspect of the present disclosure relates to an inductive hardening system for hardening a workpiece with a closed curved profile, which has a substantially radial inner surface and a substantially radial outer surface. Furthermore, the inductive hardening system comprises a workpiece holding device as described above and an induction coil for heating the workpiece. The induction coil is configured to induce an electric current in the workpiece and thus achieve a definable heat input into the workpiece in order to heat it. Particularly in the case of inductive hardening systems, it is necessary to provide a workpiece holding device that holds the workpiece securely during the heating process and at the same time enables simple and robust control of the clamping force applied to the workpiece by the workpiece holding device, even in the event of the expected thermal expansion or contraction. For this purpose, as already discussed in detail above, the workpiece holding device has at least three contact units, wherein only one contact unit is configured as an active contact unit that can be actively actuated in order to follow the thermal expansion or contraction, while the other contact units are configured passively and do not move in the radial direction during operation.

It is particularly preferable if the inductor is arranged between the two passive contact units. This means that, before the hardening process, the inductor only needs to be aligned once with the workpiece to be treated and can then be held in this position during the hardening process, as no further or only comparatively small radial displacements of the workpiece between the fixed passive contact elements are to be expected. This eliminates the need for active control of the inductor and adjustment based on the thermal expansion/contraction of the workpiece, which significantly simplifies the control of the inductive hardening system. Alternatively, the inductor can of course also be corrected and adjusted if necessary.

According to a further preferred exemplary embodiment, a laser measuring device is also provided, which is configured to determine a coupling gap between the induction coil and the workpiece. Furthermore, a control unit is provided for controlling the active contact unit, in particular the active contact element of the active contact unit, wherein the control unit is configured to control, based on the coupling gap size determined by the laser measuring device, a contact force of the active contact unit, in particular the active contact element, and/or a position of the inductor in such a way that the coupling gap between the workpiece and the induction coil is substantially constant. This can eliminate the need to actively control the inductor and adjust it based on the thermal expansion/contraction of the workpiece, which significantly simplifies the control of the inductive hardening system.

The contact units, support units and/or drive units of the tool holding device can be actuated individually or jointly.

To prevent the contact units, support units and/or drive units themselves from undergoing excessive thermal expansion/contraction, they are advantageously made of a temperature-resistant material, such as ceramic, polymer ceramic, aluminum silicate, stone, fireclay or special steel alloys.

Further advantages and advantageous embodiments are specified in the description, the drawings and the claims. In particular, the combinations of the features specified in the description and in the drawings are purely illustrative here, and therefore the features can also be present individually or in other combinations.

### BRIEF DESCRIPTION OF THE DRAWINGS

The disclosure will be described in greater detail hereinafter with reference to exemplary embodiments illustrated in the drawings. Here, the exemplary embodiments and the combinations shown in the exemplary embodiments are purely illustrative and are not intended to define the scope of protection of the disclosure. The latter is defined solely by the appended claims.

FIG. 1 is a schematic view of a workpiece holding device according to a first exemplary embodiment of the disclosure.

FIG. 2 is a schematic view of a further exemplary embodiment of a workpiece holding device.

FIG. 3 is a schematic view of a further exemplary embodiment of a workpiece holding device.

FIG. 4 is a schematic view of a further exemplary embodiment of a workpiece holding device.

FIG. 5 is a perspective view of a further exemplary embodiment of a workpiece holding device.

FIGS. 6A, 6B, 6C, 6D, 6E and 6F are schematic cross-sectional views through various embodiments of a contact element or support element of a workpiece holding device according to an embodiment of the present disclosure.

FIG. 7 is a schematic cross-sectional view through a further exemplary embodiment of a workpiece holding device.

FIG. 8 is a schematic cross-sectional view through a further exemplary embodiment of a workpiece holding device.

FIG. 9 is a schematic cross-sectional view through another exemplary embodiment of a workpiece holding device.

### DETAILED DESCRIPTION

Hereinafter, identical or functionally identically acting elements are denoted by the same reference signs.

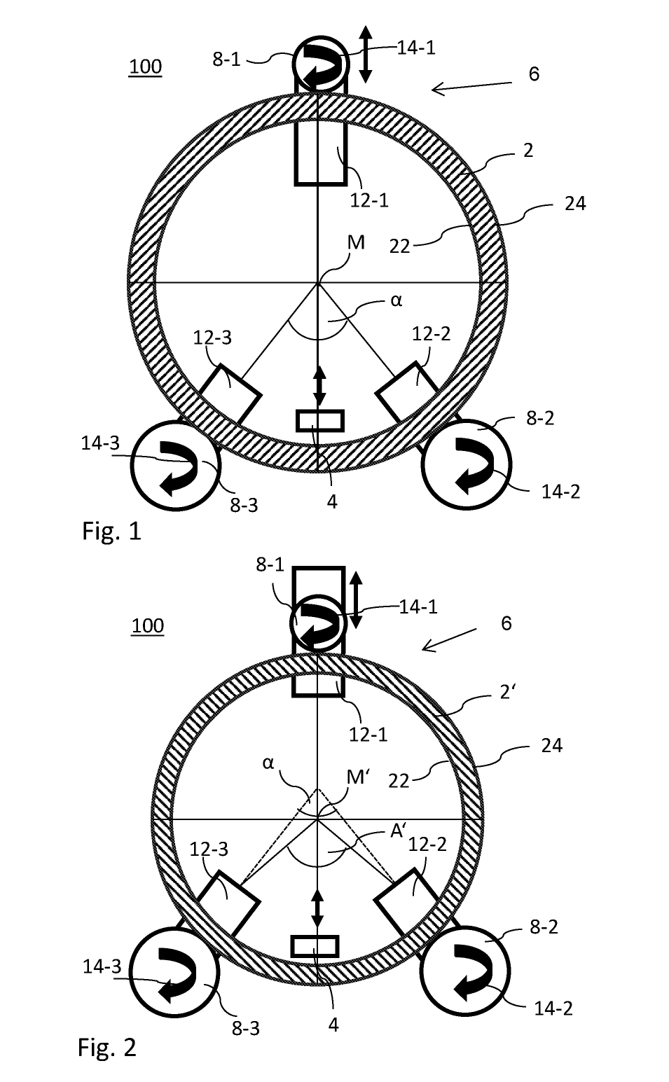

FIG. 1 is a schematic perspective view of a workpiece holding device 6 that can be used in an induction hardening system 100 to inductively harden a workpiece 2, e.g. a bearing ring, with the aid of an inductor 4. The induction hardening system 100 shown in FIG. 1 is configured as a hardening system in which the inductor 4 only heats part of the workpiece 2 at a time while the workpiece 2 is moved past the inductor 4. For this purpose, the workpiece 2 is clamped in a workpiece holding device 6 and moved past the inductor 4. The workpiece holding device 6 has at least three contact units 8-1, 8-2, 8-3 for receiving the workpiece 2, which are configured to hold the workpiece 2.

FIG. 1 also shows that, in the exemplary embodiments shown, the workpiece 2 rests on three support units 12-1, 12-2, 12-3.

The figures also show that the contact units 8-2, 8-3 are configured as so-called passive contact units, which are radially fixed, at least during operation. The contact unit 8-1, on the other hand, is configured as an active contact unit and can be adjusted in the radial direction, even during operation, in order to adapt the workpiece holding device 6 to different sizes of workpieces 2 and to be able to follow thermal expansion/contraction during heating.

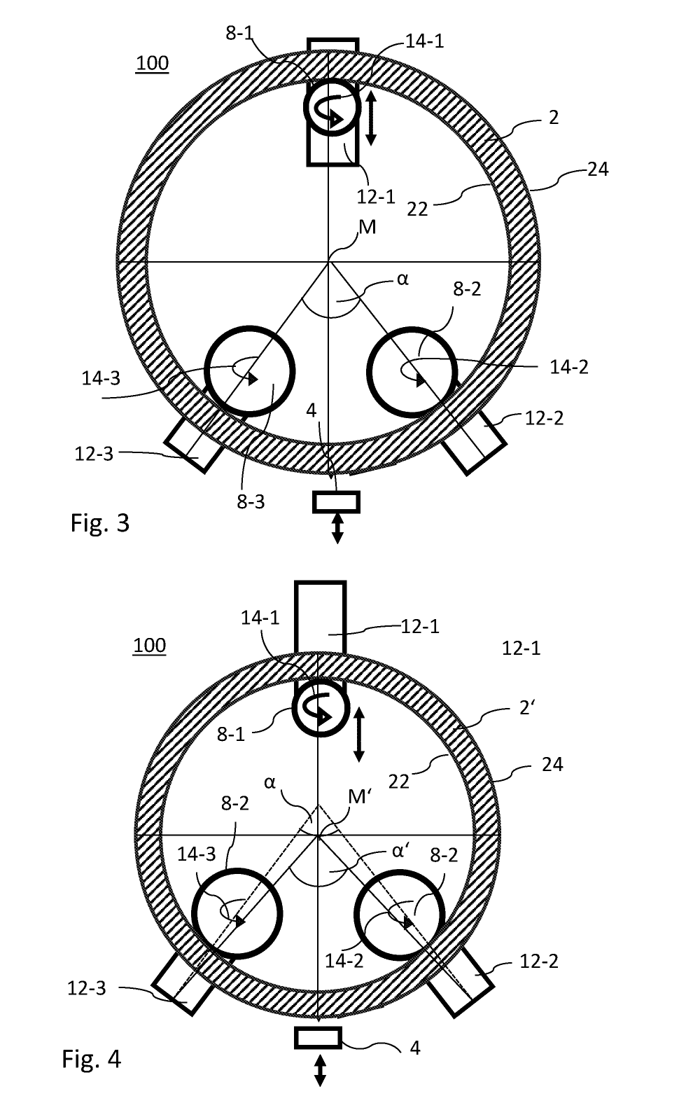

As shown in particular in the comparison between FIGS. 1 and 2 and between FIGS. 3 and 4, a larger bearing ring 2, see FIGS. 1 and 3, and a smaller bearing ring 2', see FIGS. 2 and 4, are clamped in the same workpiece holder 100. However, this also means that, starting from a center point M, M' of the bearing rings 2; 2' or the workpiece holding device 100, the contact units 8-2 and 8-3 do not form the same angle α. As can be seen from FIGS. 1 and 2 or FIGS. 3 and 4, the angle α' between the passive contact units 8-2; 8-3 is larger for the smaller bearing rings 2' (see FIGS. 2 and 4) than for the larger bearing rings 2 (see FIGS. 1; 3). In FIGS. 2 and 4, the center point M' and the angle α' of FIG. 1 are shown as dashed lines to illustrate that the contact units 8-2 and 8-3 remain in the same position for both the smaller and larger bearing rings 2'; 2.

Since only the active contact unit 8-1 needs to be radially adjustable in order to adapt to different sizes of the workpiece 2, 2', the entire workpiece holding device 6 is significantly simplified, as only a single contact unit 8-1 needs to be adapted to the size of the workpiece 2; 2'. This also ensures that, regardless of the size of the workpiece, the workpiece is always centered in the workpiece holder.

Instead of rotating the entire device 6, as in the prior art, in order to move the workpiece 2 along the inductor 4, a drive unit is also provided which is configured to rotate only the workpiece 2. In the exemplary embodiments shown in FIGS. 1-4, the contact units 8-1; 8-2; 8-3 are configured as driven contact units 14-1, 14-2, 14-3, e.g. as friction wheels or friction rollers, which form the drive units 14 and act directly on the workpiece 2, setting it in rotation (see arrow). For this purpose, the contact units 8-1, 8-2, 8-3 have, for example, driven contact elements (friction rollers). The driven contact units 14 or the driven contact elements are preferably all driven by a single motor (not shown). This can be done, for example, in the manner shown in US 18/117,600, filed Mar. 6, 2023, which is hereby incorporated by reference. This ensures that all driven contact elements 14 rotate at the same rotational speed, so that the workpiece 2 is driven evenly.

It is also possible to attach one or more measuring devices (not shown) to one or more of the contact units 8 and/or support units 12, which measuring devices are configured to measure a contact force and/or clamping force and/or friction force between the contact units 8 and/or the support units 12 and the workpiece 2. A control device (not shown) may also be provided, which interacts with the units 8, 12 and 14 in such a way that the contact units 8 and/or support units 12 interact with the workpiece 2 with a predetermined contact force, clamping force and/or friction force, or the drive unit 14 provides a corresponding rotational speed.

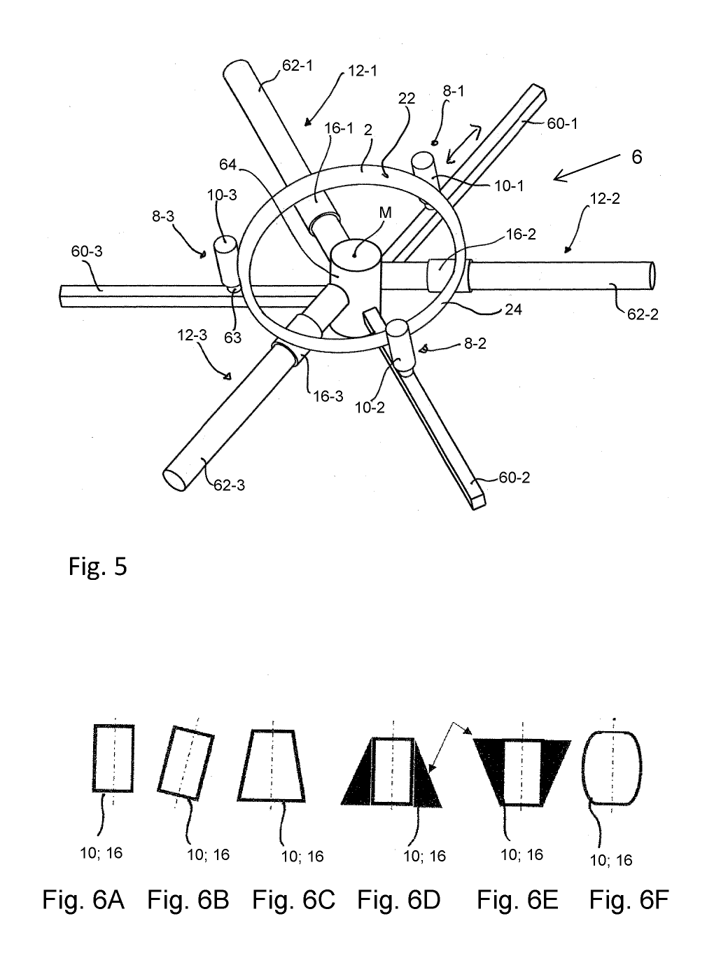

FIG. 5 shows a schematic perspective view of such a workpiece holding device 6, which can be used in an induction hardening system 100, as schematically shown in FIGS. 1-4. In the exemplary embodiment shown, the workpiece holding device 6 comprises three carriers 60-1, 60-2, 60-3 and shafts 62-1, 62-2, 62-3, which respectively carry the contact units 8 (carriers 60) and the support units 12 (shafts 62). The carriers 60 and the shafts 62 can also be configured as one-piece integral elements, as shown schematically in FIGS. 1-4. The shafts 62 and the carriers 60 are in turn attached to mounting points 64 so that the carriers 60 extend radially outwards, axially offset from a center of rotation M, the center of rotation M being determined by the rotation of the workpiece 2 in the workpiece holding device 6. The shafts and carriers can be rotatably attached to the mounting point 64.

Furthermore, FIG. 5 shows that support elements 16-1, 16-2, 16-3 are provided in the area where the workpiece 2 rests on the shafts 62, which support elements, in the embodiment shown, are configured as cylindrical sleeves that are rotatably arranged on the shafts 62. Due to the rotatability of the support elements 16, the workpiece 2 can be easily set in rotation.

Furthermore, FIG. 5 shows that the contact units 8-1, 8-2, 8-3 are provided on the carriers 60 in the form of contact elements 10-1, 10-2, 10-3 and are configured to secure the workpiece 2 in its position. The contact unit 8-1 is configured as an active contact unit and can be moved in its radial position both before the actual hardening process and during the actual hardening process. The contact units 8-2 and 8-3, on the other hand, are configured as passive contact units that cannot be moved radially, at least during operation of the induction hardening system. In order to be able to compensate for very large differences between workpieces, it is of course also possible for the passive contact elements to be configured to be radially movable for rough adjustment of the workpiece, so that they can be moved radially on the carriers 60 or on the shaft 62 until they contact the workpiece 2 and secure it in position.

Furthermore, it is shown that the contact units 8 have contact elements 10 in the form of contact rollers 10. The contact elements 10 can be configured as sleeves and can be detachably and rotatably mounted on hubs 63. The active contact element 10-1 together with its hub 63 is configured to be radially displaceable along the carrier 60-1 (see arrow) in order to be adapted to different workpieces 2. In addition, during operation, the active contact element can be actuated in such a way that it follows the workpiece and compensates for thermal expansion or contraction of the workpiece, so that the contact elements 10 always bear against the workpiece with the same contact force.

It is particularly preferable if the contact elements 10 are configured as slip-on sleeves, as shown in FIGS. 6A, 6B, 6C, 6D, 6E and 6F. The slip-on sleeve 10 may have a cylindrical (FIGS. 6A, 6B), conical (FIGS. 6C. 6D. 6E), spherical (FIG. 6F) and/or ball-shaped form. The exact shape may depend on several factors. On the one hand, the shape can be adapted to the shape or curvature of a radial inner or outer surface 22; 24 of the workpiece 2. It is particularly preferred that the slip-on sleeve contacts the workpiece 2 along a line, with the line being oriented parallel to the axis of rotation. This enables a pure rotational movement between the rotating element and the workpiece without any sliding movement. However, it is equally possible to select the shape for minimal contact but sufficient clamping force. The shape may also be selected on the basis of rotational considerations. Furthermore, it is possible that the contact units 8-1 to 8-3 have differently configured slip-on sleeves. In particular, it may be provided that the slip-on sleeve 10-1 of the active contact unit 8-1 is configured differently from the slip-on sleeves 10-2; 10-3 of the passive contact units 8-2; 8-3.

According to a further preferred exemplary embodiment, the hub 63 can also be angled with the aid of an adjustment device (not shown), as also schematically indicated in FIG. 6B. This also allows the rotating elements to be adapted particularly well to the geometry of the workpiece. For example, with the aid of the adjustment device, it is possible to use a cylindrical rotatable element even for inclined radial surfaces and still guide the rotating element with line contact on the workpiece. Alternatively, a conical sleeve, as shown in FIGS. 6C-6D, could also be used here.

Alternatively or additionally, the contact units 8, or at least one of the contact units 8, can be configured as driven contact units 14. In this case, it is particularly preferable if the contact element 10 is configured, for example, as a friction roller that rubs against the workpiece 2 and is actively set in rotation in order to turn the workpiece 2. The friction roller may also have a cylindrical, conical, spherical, toroidal and/or ball-like shape, as shown in FIG. 6. Alternatively or additionally, a driven support element 16 may be provided in addition to the driven contact element 10.

The rotatable support elements 16 of the support units 12 can also be configured as interchangeable sleeves with the shapes shown in FIGS. 6A-6F as examples. This allows them to ensure low-friction and tilt-proof mounting of the workpiece 2 while also providing particularly good accessibility to the surfaces to be treated. On the other hand, the flexible design using the interchangeable sleeves also allows adaptation to the shape of the workpiece itself.

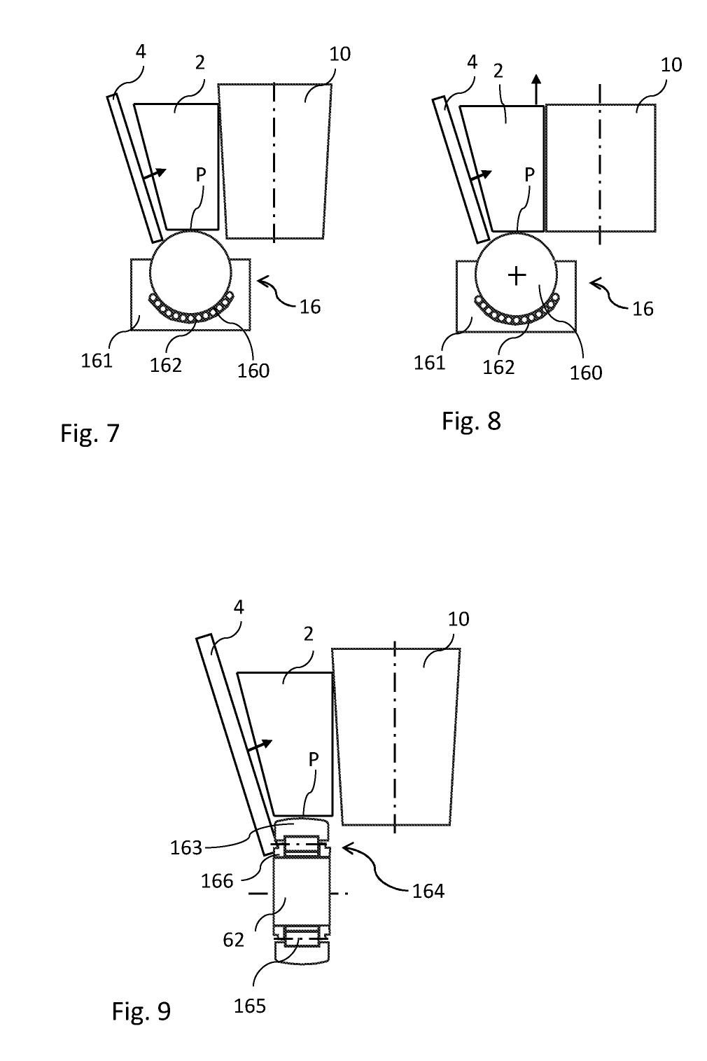

A particularly preferred exemplary embodiment is one in which the contact element 10 has a conical shape, as shown in FIG. 7. This ensures, as shown in FIGS. 7 and 8, among others, that the workpiece is held on the support element 16, as any upward movement induced by the inductor 4 is reliably prevented. If the contact element 10 is configured as a cylinder, as shown in FIG. 8, the workpiece can move upwards away from the support element 16. Thus, a conical contact element 10 also functions as a hold-down device.

Of course, separate hold-down devices (not shown) can also be used to apply axial tension to the workpiece 2. Hold-down devices are used in particular for lightweight workpieces and high magnetic field strengths of the inductor 4 in order to hold the workpiece securely and accurately in position in the workpiece holding device 100.

Furthermore, FIGS. 7 and 8 show an exemplary embodiment in which the support element 16 is configured as a ball 160. As a result, the workpiece 2 only contacts the support element 16 at one point P. The ball 160, in turn, is mounted rotatably in a ball carrier 161, for example by means of further balls 162, as shown in FIGS. 7 and 8, or slidingly in a ball receptacle.

The point-based mounting allows the workpiece 2 to rest on the support element 16 in a particularly friction-free and slip-free manner, so that the workpiece can rotate quickly and without excessive energy expenditure via the support elements 16.

Instead of a ball element 160, the support element 16 can also be configured via a rotatably mounted sleeve element 163, wherein the sleeve element 166 has a spherical shape, which in turn contacts the workpiece 2 at only one point P. The sleeve element can, of course, be fitted onto the shaft 62 with sliding friction, but it is also possible, as shown in FIG. 9, to mount the sleeve element 163 via a rolling bearing 164, wherein, for example, the sleeve element 163 can be configured as an outer ring. In this case, the shaft 62 can continue to function as the inner ring of the rolling bearing 164. Rolling elements 165 then roll on the inner side of the sleeve element 163 and the outer side of the shaft 62. In order to secure the sleeve element axially on the shaft 62, a clamping ring 166 may also be provided, which secures the rolling elements 165 and thus also the sleeve element 163 axially in their position.

Of course, instead of the clamping ring 166, an inner ring may also be mounted on the shaft 62, on which inner ring the rolling elements 165 roll.

Both the clamping ring 166 and the inner ring are preferably mounted on the shaft 62 so that they can be moved axially in order to position the sleeve element 163 in relation to the workpiece 2. In the exemplary embodiment shown, however, the sleeve element 163 and the ball 160 are configured as passive support elements that are moved solely by the rotation of the workpiece 2.

In order to set the workpiece 2 in rotation, at least one of the contact elements 10 is configured as a drive element. Furthermore, however, the workpiece 2 can move slightly back and forth axially on the ball element 160 or on the sleeve element 163 in order, for example, to follow and/or compensate for thermal expansion and/or contraction during heating and/or manufacturing-related unbalances.

Overall, the flexible design of the clamping units and support units allows the workpiece holding device to be particularly well adapted to various shapes of workpieces. At the same time, the design of only one contact unit as an active contact unit that can follow thermal expansion or contraction ensures a particularly easy-to-adjust and robust system. This makes it possible to provide an easy-to-use, individually adjustable device that can be used universally for a wide range of workpieces.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved workpiece holding devices.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A workpiece holding device for holding a workpiece having a curved inner surface and a curved outer surface in a heat treatment system, the workpiece holding device comprising:
at least three support units configured to support the workpiece for rotation about a workpiece rotational axis, and
a first contact unit, a second contact unit and a third contact unit configured to cooperate with the workpiece to limit translational movement of the workpiece in a radial plane of the workpiece during a rotational movement of the workpiece relative to a heating device,
wherein the workpiece is configured to undergo a thermal expansion during a heating by the heating device and a thermal contraction after the heating by the heating device,
wherein the first contact unit, the second contact unit and the third contact unit are configured such that a distance between the second contact unit and the third contact unit is fixed during the thermal expansion and during the thermal contraction and such that a distance between the first contact unit and the second contact unit is changeable during the thermal expansion and during the thermal contraction, and
wherein the first contact unit is configured to apply a radial clamping force to the workpiece to press the workpiece against the second contact unit and the third contact unit.

2. The workpiece holding device according to claim 1,
wherein the first contact unit includes a first contact element and the second contact unit includes a second contact element and the third contact unit includes a third contact element, and
wherein the first, second and third contact elements are configured to directly contact the curved inner surface or the curved outer surface of the workpiece.

3. The workpiece holding device according to claim 1,
wherein the first contact unit or the second contact unit or the third contact unit is a rotatable contact unit operably connected to a drive unit for rotating the rotatable contact unit, and
wherein the rotatable contact unit is configured to rotate the workpiece by frictional engagement with the workpiece.

4. The workpiece holding device according to claim 2,
wherein at least one of the contact elements is configured as a rotatable contact element configured to bear against the workpiece.

5. The workpiece holding device according to claim 4,
wherein each of the at least three support units include a rotatable support element configured to contact the workpiece.

6. The workpiece holding device according to claim 5,
wherein the rotatable support elements comprise non-driven support elements.

7. The workpiece holding device according to claim 6,
wherein each of the non-driven support elements comprises a ball.

8. The workpiece holding device according to claim 6,
wherein each of the non-driven support elements comprises a spherical sleeve element.

9. The workpiece holding device according to claim 5,
wherein at least one of the contact elements is detachably connected to a respective one of the contact units; and/or
wherein at least one of the support elements is detachably connected to a respective one of the support units.

10. The workpiece holding device according to claim 5,
wherein at least one contact unit and/or at least one support unit further comprises an adjustment device which is configured to adjust an angular position of the contact element and/or support element.

11. The workpiece holding device according to claim 1,
wherein the first contact unit is preloadable against the workpiece to apply a predetermined contact force against the workpiece, and
wherein the first contact unit is configured to move with the radially in response to the thermal expansion and in response to the thermal contraction.

12. The workpiece holding device according to claim 3,
including a control unit configured to control the radial clamping force of the first contact unit and/or to control a speed of the drive unit.

13. An induction hardening system comprising:
a workpiece holding device according to claim 1,
the workpiece supported by the at least three support units, and
the heating device, wherein the heating device comprises an inductor.

14. The induction hardening system according to claim 13,
wherein the inductor is arranged between the second contact unit and the third contact unit.

15. The induction hardening system according to claim 13, including:
a laser measuring device configured to determine a coupling gap between the inductor and the workpiece, and
a control unit configured to control the first contact unit based on the coupling gap to maintain a predetermined size of the coupling gap.

16. A system comprising:
a workpiece holding device according to claim 1, and
the workpiece,
wherein the workpiece is supported by the at least three support units,
wherein the first contact unit, the second contact unit and the third contact unit contact a radially outer surface of the workpiece, and
wherein the first contact unit is configured to maintain a substantially constant radial clamping force on the workpiece while the workpiece undergoes the thermal expansion and the thermal contraction.
